(19) United States
(12) Patent Application Publication
(10) Pub. No.: US 2020/0287339 A1
(43) Pub. Date: Sep. 10, 2020

(54) PLUG HOUSING WITH INTEGRATED CORD MANAGEMENT SYSTEM

(71) Applicant: ISquared L.L.C, Rapid City, SD (US)

(72) Inventors: Cade Christian Ellis, Bozeman, MT (US); Michael Anthony Hubbard, Rapid City, SD (US)

(21) Appl. No.: 16/811,107

(22) Filed: Mar. 6, 2020

Related U.S. Application Data
(60) Provisional application No. 62/815,577, filed on Mar. 8, 2019.

(51) Int. Cl. H01R 31/06; H02J 7/00

(52) U.S. Cl. CPC H01R 31/06; H02G 11/02; H02J 7/0044

(57) ABSTRACT

Disclosed embodiments relate generally to a device configured to securely but removably house a charger plug (e.g. for an iPhone, smart phone, cell phone, or similar personal electronic device). Typically, the device comprises a hollow central housing with open cavity therethrough (configured to house the charger plug), an upper flange, and a lower flange. A cord for the changer plug may be retained by wrapping around the exterior of the housing between the two flanges, and in some embodiments, the flanges may also contain one or more cord retaining features (such as a notch) configured to removably retain the cord. Thus, the device has two configurations: a storage configuration in which the cord is wrapped around the central housing with the ends retained in the notches, and a use configuration when all or part of the cord is unwound from the central housing (and typically one or both ends of the cord are removed from the retaining notch(es), so that the cord can be plugged into the charger plug held within the cavity of the housing and/or plugged into a power source (such as a laptop or other computer or a wall plug).

### CROSS-REFERENCE TO RELATED APPLICATIONS

This application claims priority to U.S. Provisional Patent Application Ser. No. 62/815,577, filed Mar. 8, 2019 and entitled “Plug Housing with Integrated Cord Management System,” which is incorporated herein in its entirety.

### STATEMENT REGARDING FEDERALLY SPONSORED RESEARCH OR DEVELOPMENT

Not applicable.

### REFERENCE TO A MICROFICHE APPENDIX

Not applicable.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates a front perspective view of a plug housing with integrated cord management system in accordance with an embodiment of the disclosure;

FIG. 2 illustrates a top plan view of the plug housing with integrated cord management system in accordance with an embodiment of the disclosure;

FIG. 3 illustrates a bottom plan view of the plug housing with integrated cord management system in accordance with an embodiment of the disclosure;

FIG. 4 illustrates a front elevation view of the plug housing with integrated cord management system in accordance with an embodiment of the disclosure;

FIG. 5 illustrates a rear elevation view of the plug housing with integrated cord management system in accordance with an embodiment of the disclosure;

FIG. 6 illustrates a right side elevation view of the plug housing with integrated cord management system in accordance with an embodiment of the disclosure; and

FIG. 7 illustrates a left side elevation view of the plug housing with integrated cord management system in accordance with an embodiment of the disclosure.

### DETAILED DESCRIPTION

It should be understood at the outset that although illustrative implementations of one or more embodiments are illustrated below, the disclosed systems and methods may be implemented using any number of techniques, whether currently known or not yet in existence. The disclosure should in no way be limited to the illustrative implementations, drawings, and techniques illustrated below, but may be modified within the scope of the appended claims along with their full scope of equivalents.

The following brief definition of terms shall apply throughout the application:

The term “comprising” means including but not limited to, and should be interpreted in the manner it is typically used in the patent context;

The phrases “in one embodiment,” “according to one embodiment,” and the like generally mean that the particular feature, structure, or characteristic following the phrase may be included in at least one embodiment of the present invention, and may be included in more than one embodiment of the present invention (importantly, such phrases do not necessarily refer to the same embodiment);

If the specification describes something as “exemplary” or an “example,” it should be understood that refers to a non-exclusive example;

The terms “about” or “approximately” or the like, when used with a number, may mean that specific number, or alternatively, a range in proximity to the specific number, as understood by persons of skill in the art field (for example, ±10%); and

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

Generally, the disclosed embodiments relate to a plug housing with integrated cord management system device as described herein, which for example may be a housing for a charger/plug (for example, for a plug for a personal electronic device such as a cell phone, smart phone, iPhone, etc.) with an integrated cord management and/or retention system. Typically, the housing might include an opening (e.g. cavity) therethrough which is configured to snuggly (i.e., securely, temporarily, removably) hold such a charger/plug within the interior of the housing (e.g. within the cavity), while providing a location for the corresponding charger cord to be retained about the exterior of the housing. In some embodiments, the housing would have an upper flange and a lower flange (e.g. with the upper flange extending outward from the top of the exterior of the housing and the lower flange extending outward from the bottom of the exterior of the housing), for example allowing a cord to be retained by wrapping around the exterior of the central housing in the space between the upper and lower flanges. And in some embodiments, the cord retaining feature would further include notches (e.g. retaining via an interference-type fit) or other integrated elements configured to removably secure/hold the cord in place. In other embodiments, some other cord management/retention system (e.g. located on the exterior of the central housing and/or flange(s)) might be employed.

So, in use, the charger/plug might be inserted and housed within the central housing (e.g. within the cavity), while the related/corresponding cord might be wrapped around the exterior of the housing and, sometimes optionally, one or more end of the cord might be secured by being inserted into one or more notches in the flanges. The cavity is typically a through-hole (e.g. extending all the way through the housing, for example from the top to the bottom), such that when the charger/plug is housed within the cavity of the central housing, the prongs of the plug may stick out one side of the open cavity of the housing (e.g. the top), while the open bottom of the cavity/housing may allow for the cord to be plugged into the charger/plug without having to remove the charger/plug from the central housing. This may occur with the cord completely unwrapped from the central housing, or a portion of the cord could still be wrapped around and/or secured to the housing and/or flange(s).

Typically, the cavity would be sized to snuggly hold the charger/plug within the cavity, while allowing its removal (e.g. when sufficient force is exerted to slide the charger/plug/port out of the housing). For example, the removable, snug fit may be due to tight tolerances (e.g. the cavity is sized approximately the same size and/or shape (e.g. cross-sectional dimensions) as the charger/plug, providing a friction and/or interference fit) where the material of the housing may be chosen with characteristic to facilitate the snug fit (e.g., flexibility, rebound, friction, etc.). As another example, (or in addition to the other examples) the interior of the housing (e.g. the cavity walls) may be configured to provide a secure grip via a high friction material, etc.

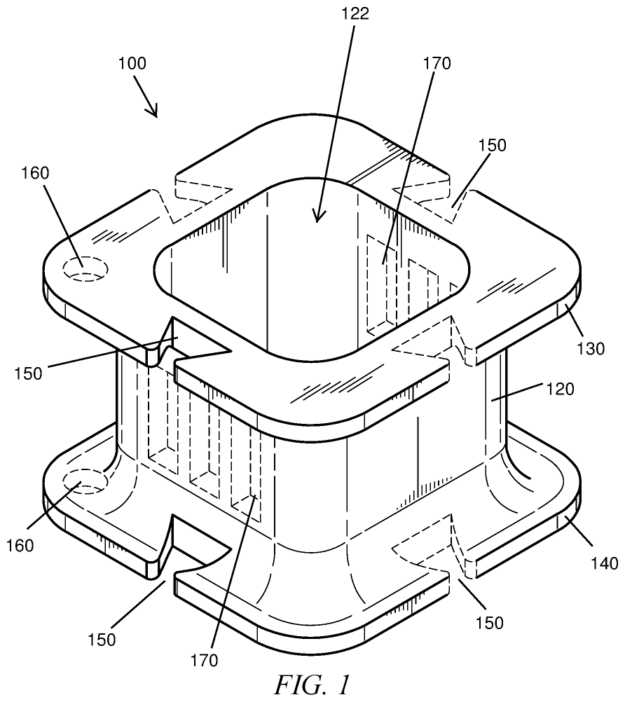

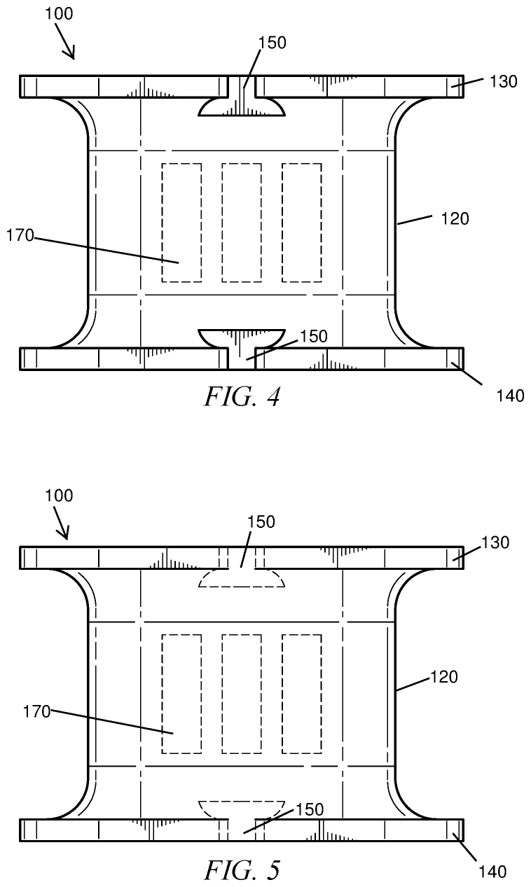

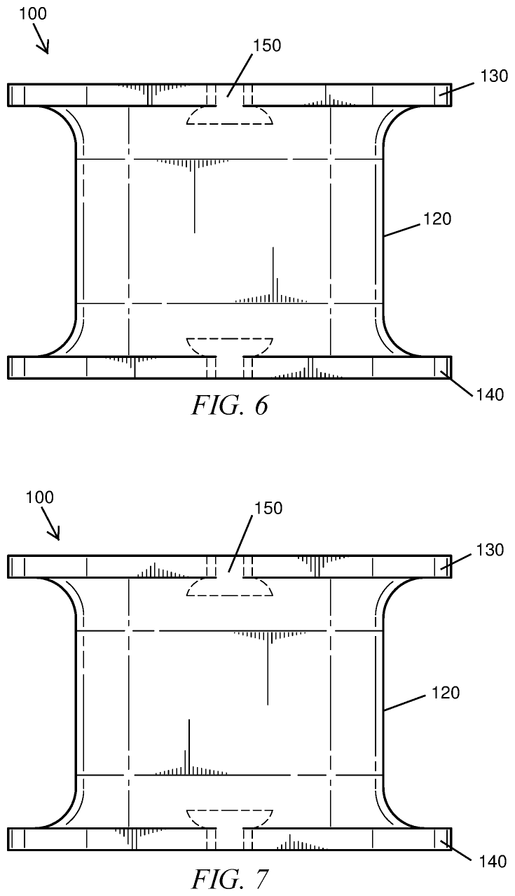

Embodiments of the disclosure are shown in FIGS. 1-7. In FIGS. 1-7, the device 100 comprises a body having a hollow central housing 120 (wherein the shape of the housing 120 may be determined by the shape of the charger/plug to be fitted within the housing 120, which typically may be cube-like), with an open cavity 122 therethrough, and an upper flange 130 and a lower flange 140 extending from the exterior of the central housing 120 (typically extending from the entire perimeter of the housing). The upper flange 130 typically would be located in proximity to the top surface of the central housing 120 (e.g. flush with the top surface), and the lower flange 140 would typically be located in proximity to the bottom surface of the central housing 120 (e.g. flush with the bottom surface), and both flanges 130 and 140 would typically extend outward approximately perpendicularly from the central housing 120 (e.g. perpendicular to the exterior of the central housing and/or the central axis of the cavity in the housing). And typically, each of the flanges 130, 140 would extend outward (e.g. perpendicularly) from the entire perimeter of the top or bottom surface, with each such flange 130, 140 essentially ringing the housing 120. Thus, typically the central housing 120 walls extend approximately perpendicularly between the two flanges 130, 140 (e.g. the upper and lower flanges), with the upper flange 130 typically located about the top surface of the housing 120 and the lower flange 140 located about the bottom surface of the housing 120. And typically, the central housing 120 is approximately box-like or cube-like (with four side walls and at least one (e.g., two) open faces (typically opposite each other) for the cavity 122 providing the through-hole). The height of the central housing 120 between the flanges 130, 140 is typically configured based on the height of the charger/plug/port to be held within the cavity of the housing 120 and/or the amount of space needed for the corresponding cord (for the charger/plug/port) to wrap around for storage when fully retained. Oftentimes, the central housing 120 would have height, width, and length all approximately equal in dimension.

In FIGS. 1-7, the flanges 130, 140 each have one or more cord retaining feature 150, such as a notch, configured to grip a cord (e.g. for the charger/plug to be inserted/housed within the device cavity) and securely (but removably) hold it in place. In some embodiments, each flange 130, 140 would have a plurality of such notches 150, and in some embodiments each flange 130, 140 would have four (4) notches 150, for example spaced so that each side of the (typically square-like) flange has a notch (which may be located in the center of the corresponding side). Typically, each notch 150 would be shaped so that the ingress (located at the distal end of the flange) is narrower and widens as extending inward on the flange (e.g. towards the proximal end of the flange). For example, the ingress portion of the notch might be slightly smaller in width than the (uncompressed) diameter of the cord to be held, while the wider, proximal portion of the notch might be slightly wider than the diameter of the cord to be held, such that the notch would be configured to provide an interference fit for the retained cord. Thus, the cord could be inserted into the notch by pressing the cord through the ingress (e.g. with the cord (sheathing) compressing to squeeze through the ingress), with the cord then returning to its original (larger/uncompressed) diameter after pressing through the ingress into the wider portion of the notch; that larger (uncompressed) cord diameter (e.g. larger than the width of the ingress) would then act to removably retain the cord in place within the notch. Removal of the cord from the notch might be in reverse, for example pulling the cord against the ingress until the cord diameter is squeezed sufficiently to reduce to the size (e.g. width) of the ingress (thereby allowing removal of the cord, which after removal could return to its original/uncompressed/un-deformed diameter). In the embodiment of FIG. 1, the width of the notch widens, as extending from the distal end inward towards the proximal end of the flange, in equilateral triangular fashion, since this shape may provide the benefit of automatically guiding the cord to the ingress as it is pulled out from the notch during removal (which may help minimize damage to the cord during the removal process).

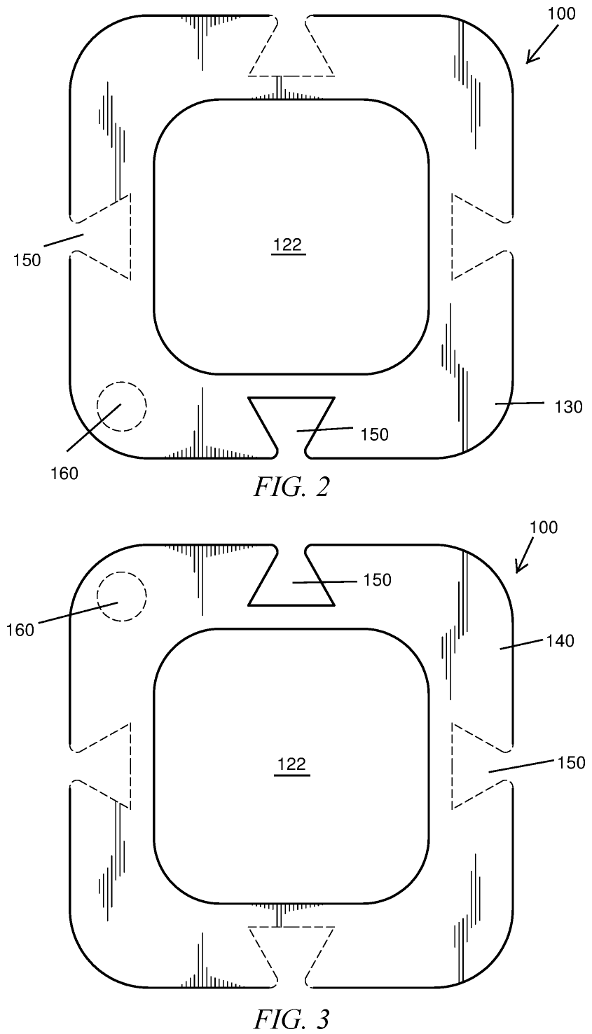

In the embodiment of FIGS. 2-3, the notches 150 on the upper flange 130 are aligned vertically with the notches 150 on the lower flange 140. And in FIGS. 1-3, one or both flanges 130, 140 may also include an aperture 160 configured for attachment to a key chain (e.g. a key chain ring hole). Typically, the entire device 100 (e.g. which may have a plug inserted therein and a cord wrapped around it) would fit conveniently in a user's pocket.

The cavity 122 of the central housing 120 is typically sized to snuggly retain the charger/plug/port. In some embodiments, the central housing 120 may comprise an elastic or otherwise expandable element (e.g. the entire central housing could be made of an elastic or flexible material, each side wall could include a portion of elastic or flexible material, etc.), allowing the central housing 120 to fit and snuggly hold a range of differently sized chargers/plugs/ports. In some embodiments, the inner surface of the housing 120 (e.g. the surface of the cavity 122) may be configured to increase friction (e.g. may be rubberized or textured, etc.) to improve retaining grip between the cavity 122 and the charger/port/plug. Typically, any outer corners for the flanges 130, 140 would be rounded (or the flanges would not have any sharp corners, for example the flanges could be circular or oval in shape), to minimize snagging. Often, the corners of the central housing 120 would also be rounded (e.g. to allow convenient wrapping and/or unwrapping of the cord around the central housing without damage to the cord) and/or the corners of the cavity 122 would also be rounded (e.g. depending on and/or matching the charger design). And typically, the cavity 122 may be cube-like, for example with a height, width, and length approximately equal in dimension. And often, the distal corners/edges of the notches 150 would also be rounded, to ensure that the cord can easily be pressed into the ingress of the notch without damaging the cord (e.g. as the cord is thereby deformed to fit through the ingress of the notch during insertion and/or removal).

In some embodiments, as shown in FIGS. 1, 4, and 5, the housing 120 may also comprise side vents 170. For example, in FIGS. 1, 4, and 5, two side walls of the central housing 120 (e.g. opposite each other) may have vents 170, which might be for example three rectangular openings through the side walls extending from the exterior of the housing into the cavity. Such side vents might provide airflow for cooling of the charger/plug/port while it is held within the housing 120 and/or may reduce the overall weight of the device. Additionally, the vents 170 may be sized small enough to not interfere with or reduce the efficacy of the retaining of the charger/plug/port within the cavity 122 of the housing 120.

In use, the device typically has two configurations: a first (e.g. storage) configuration, in which the plug is inserted within the central housing and the cord is wrapped around the central housing entirely (or at least mostly) and both ends of the cord are retained fixedly in place (e.g. within notches); and a second (e.g. use) configuration, in which at least a portion of the cord is unwound from the central housing so that one end of the cord (typically now not held in the retaining notch) plugs into the charger/plug and the other end of the cord (typically now not held in the retaining notch) plugs into a computer, mobile device, or other device (e.g., where the other device may be configured to provide power to the charger/plug/port, and/or may be configured to receive power from or via the charger/plug/port). Typically, in storage mode, the cord wraps around the central housing between the two flanges, with one end of the cord securely (but removably) held in place in a notch on the top flange and the other end of the cord securely (but removably) held in place in a notch on the bottom flange.

Oftentimes, the device is formed of plastic (e.g. ABS plastic), and may be molded, printed, or extruded. Typically, the device is formed as a single unified element (e.g. with the flanges integrally formed and attached to the central housing body).

The Appendix (fully incorporated herein as part of this disclosure) provides further informative exemplary illustrations of various embodiments which may be similar to the disclosed embodiments above, all of which are included within the scope of this disclosure. By way of example with regard to the Appendix, page 1 shows a perspective image of an exemplary plug housing with integrated cord management system device; page 2 shows multiple views (e.g. side elevation and cross-section) of an exemplary plug housing with integrated cord management system device; page 3 shows multiple views of an exemplary plug housing with integrated cord management system device (e.g. top plan view and a detail enlarged portion showing an exemplary cord retaining notch/feature); page 4 shows a perspective photograph of an exemplary prototype of a plug housing with integrated cord management system device; page 5 shows a side elevation photograph of an exemplary prototype of a plug housing with integrated cord management system device; page 6 shows a perspective photograph of an exemplary prototype of a plug housing with integrated cord management system device with an exemplary charger plug housed therein (e.g. located within the open through-cavity in the plug housing with integrated cord management system housing) and an exemplary (power) cord wrapped around the housing with ends each retained within retaining notches located on the flanges of the plug housing with integrated cord management system); page 7 shows a perspective photograph of an exemplary prototype of a plug housing with integrated cord management system device with an exemplary charger plug housed therein (e.g. located within the open through-cavity in the plug housing with integrated cord management system housing); and page 8 shows a side elevation photograph of an exemplary prototype of a plug housing with integrated cord management system device with an exemplary charger plug housed therein (e.g. located within the open through-cavity in the plug housing with integrated cord management system housing, with prongs of the plug extending out from the plug housing with integrated cord management system).

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above but is defined by the claims which follow that scope including all equivalents of the subject matter of the claims. Each and every claim is incorporated as further disclosure into the specification and the claims are embodiment(s) of the present invention(s). Furthermore, any advantages and features described above may relate to specific embodiments but shall not limit the application of such issued claims to processes and structures accomplishing any or all of the above advantages or having any or all of the above features.

Additionally, the section headings used herein are provided for consistency with the suggestions under 37 C.F.R. 1.77 or to otherwise provide organizational cues. These headings shall not limit or characterize the invention(s) set out in any claims that may issue from this disclosure. Specifically, and by way of example, although the headings might refer to a “Field,” the claims should not be limited by the language chosen under this heading to describe the so-called field. Further, a description of a technology in the “Background” is not to be construed as an admission that certain technology is prior art to any invention(s) in this disclosure. Neither is the “Summary” to be considered as a limiting characterization of the invention(s) set forth in issued claims. Furthermore, any reference in this disclosure to “invention” in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of the claims shall be considered on their own merits in light of this disclosure but should not be constrained by the headings set forth herein.

Use of broader terms such as “comprises,” “includes,” and “having” should be understood to provide support for narrower terms such as “consisting of,” “consisting essentially of,” and “comprised substantially of.” Use of the terms “optionally,” “may,” “might,” “possibly,” and the like with respect to any element of an embodiment means that the element is not required, or alternatively, the element is required, both alternatives being within the scope of the embodiment(s). Also, references to examples are merely provided for illustrative purposes, and are not intended to be exclusive.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented.

Also, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

What is claimed is:

1. A device (e.g. a plug housing with integrated cord management/retainer) comprising:
a hollow central housing/body (e.g. which may be approximately box-like or cube-like) having an open cavity therethrough configured to snugly/securely fit around a (separate) charger to removably secure a (separate) charger/plug (e.g. a mobile device charger plug);
an upper flange securely attached/affixed to and extending from a top surface of the central housing, wherein the flange extends out from (and surrounds) the entire top surface perimeter of the central housing; and
a lower flange securely attached/affixed to and extending from a bottom surface of the central housing, wherein the flange extends out from (and surrounds) the entire bottom surface perimeter of the central housing.

2. The device of claim 1 wherein the flanges extend out perpendicular to a central axis of the cavity.

3. The device of claim 1 wherein the cavity is approximately uniform in shape and size as it extends through the central housing from the top surface to the bottom surface.

4. The device of claim 1 wherein the housing (located between the upper and lower flanges) extends out perpendicularly between the flanges at the proximal end of the flanges (e.g. with the flanges located on the distal surface of the housing).

5. The device of claim 1 wherein each of the upper and lower flanges comprises one or more notches (e.g. located on the distal end of the flanges) configured to removably retain a cord which has been inserted therein.

6. The device of claim 5 wherein each of the upper and lower flanges comprises four (4) notches (e.g. with the notches in the upper flange aligned vertically with the notches in the lower flange).

7. The device of claim 1 wherein the housing comprises one or more vent slots (e.g. with each such vent slot penetrating a side wall of the central housing to provide an opening from the exterior of the central housing, through the side wall, to the open cavity).

8. The device of claim 5 wherein each notch comprises a narrower ingress (e.g. slightly smaller than the (uncompressed) diameter of the cord to be retained, but typically sufficiently wide so that the cord may (e.g. elastically) compress (to a compressed diameter) and pass through the notch and then spring back to its uncompressed diameter) at the distal end of the flange and widens as extending inward on the flange (e.g. toward the proximal side of the flange) (e.g. with the wider portion for example being slightly wider than the uncompressed diameter of the cord).

9. The device of claim 1 wherein one or both flanges comprises an aperture configured for key chain attachment (e.g. a key chain ring).
